(19) United States
(12) Patent Application Publication
(10) Pub. No.: US 2016/0078020 A1
(43) Pub. Date: Mar. 17, 2016

(54) SPEECH TRANSLATION APPARATUS AND METHOD

(71) Applicants: KABUSHIKI KAISHA TOSHIBA, Tokyo (JP); TOSHIBA SOLUTIONS CORPORATION, Kawasaki-shi (JP)

(72) Inventors: Kazuo SUMITA, Yokohama Kanagawa (JP); Satoshi KAMATANI, Kawasaki Kanagawa (JP); Kazuhiko ABE, Tokyo (JP); Kenta CHO, Kawasaki Kanagawa (JP)

(73) Assignees: KABUSHIKI KAISHA TOSHIBA, Tokyo (JP); TOSHIBA SOLUTIONS CORPORATION, Kawasaki-shi (JP)

(21) Appl. No.: 14/848,319

(22) Filed: Sep. 8, 2015

(30) Foreign Application Priority Data
Sep. 11, 2014 (JP) 2014-185583

(51) Int. Cl. G06F 17/28; G10L 15/26

(52) U.S. Cl. CPC G06F 17/289; G10L 15/26

(57) ABSTRACT

According to one embodiment, a speech translation apparatus includes a recognizer, a detector, a convertor and a translator. The recognizer recognizes a speech in a first language to generate a recognition result. The detector detects translation segments suitable for machine translation from the recognition result to generate translation-segmented character strings that are obtained by dividing the recognition result based on the detected translation segments. The convertor converts the translation-segmented character strings into converted character strings which are expressions suitable for the machine translation. The translator translates the converted character strings into a second language which is different from the first language to generate translated character strings.

### CROSS-REFERENCE TO RELATED APPLICATIONS

This application is based upon and claims the benefit of priority from Japanese Patent Application No. 2014-185583, filed Sep. 11, 2014, the entire contents of which are incorporated herein by reference.

### FIELD

Embodiments described herein relate generally to a speech translation apparatus and method.

### BACKGROUND

Demands for translation devices that support communication between users who speak different languages are increasing as globalization progresses. A speech translation application operating on a terminal device like a smart phone is an example of such translation devices. A speech translation system that can be used at conferences and seminars has also been developed.

### BRIEF DESCRIPTION OF THE DRAWINGS

FIG. 1 is a block diagram showing a speech translation apparatus according to the first embodiment.

FIG. 2 is a drawing showing an example of a discrimination model generated for use at a translation segment detector.

FIG. 3 is a drawing showing an example of detection of a translation segment using a discrimination model.

FIG. 4 is a drawing showing an example of a conversion dictionary referred to by a words and phrases convertor.

FIG. 5 is a flowchart showing an operation of the speech translation apparatus according to the first embodiment.

FIG. 6 is a drawing showing timing of generating a recognition result character string and timing of detecting translation segments.

FIG. 7 is a drawing showing examples of character strings outputted at the speech translation apparatus.

FIG. 8 is a drawing showing display examples on the display according to the first embodiment.

FIG. 9 is a block diagram showing a speech translation system according to the second embodiment.

FIG. 10 is a drawing showing examples of data stored in a data storage.

FIG. 11 is a flowchart showing an operation of the speech translation server according to the second embodiment.

FIG. 12 is a flowchart illustrating a speech outputting process at a terminal.

FIG. 13 is a drawing showing display examples on the display according to the second embodiment.

FIG. 14 is a drawing showing a first variation of displays on the display.

FIG. 15 is a drawing showing a second variation of displays on the display.

FIG. 16 is a block diagram showing a terminal (speech translation apparatus) when communication is directly carried out between terminals.

### DETAILED DESCRIPTION

A common speech translation application is expected to be used for translating simple conversations, such as a conversation during a trip. Furthermore, at a conference or a seminar, it is difficult to set restraints on a speech manner of a speaker; thus, there is a need for a processing capable of translating spontaneous speech. However, the aforementioned speech translation system is not designed for translating spontaneous speech input.

In general, according to one embodiment, a speech translation apparatus includes a recognizer, a detector, a convertor and a translator. The recognizer recognizes a speech in a first language to generate a recognition result character string. The detector detects translation segments suitable for machine translation from the recognition result character string to generate translation-segmented character strings that are obtained by dividing the recognition result character string based on the detected translation segments. The convertor converts the translation-segmented character strings into converted character strings which are expressions suitable for the machine translation. The translator translates the converted character strings into a second language which is different from the first language to generate translated character strings.

Hereinafter, the speech translation apparatus, method, and program according to the present embodiment will be described in detail with reference to the drawings. In the following embodiments, the elements which perform the same operation will be assigned the same reference symbols, and redundant explanations will be omitted as appropriate.

In the following embodiments, the explanation will be on the assumption of speech translation from English to Japanese; however, the translation may be from Japanese to English, or any other combination of two languages. Moreover, speech translation between three or more languages can be processed in a same manner as described in the embodiments.

### First Embodiment

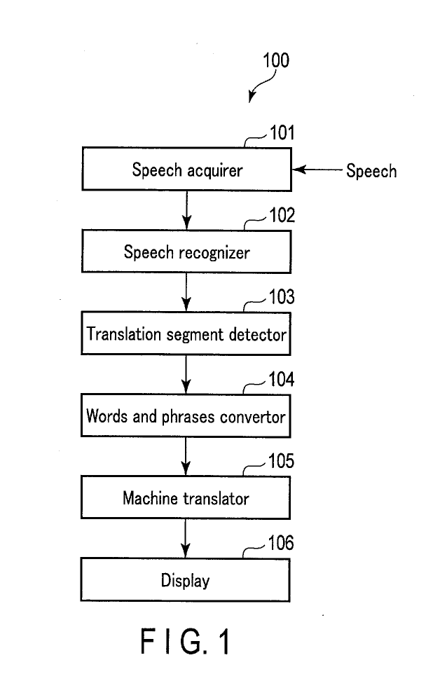

The speech translation apparatus according to the first embodiment is explained with reference to the block diagram of FIG. 1.

The speech translation apparatus 100 according to the first embodiment includes a speech acquirer 101, a speech recognizer 102, a translation segment detector 103, a words and phrases convertor 104, a machine translator 105, and a display 106.

The speech acquirer 101 acquires an utterance in a source language (hereinafter “the first language”) from a user in the form of a speech signal. Specifically, the speech acquirer 101 collects a user's utterance using a microphone, and performs analog-to-digital conversion on the utterance to convert the utterance into digital signals.

The speech recognizer 102 receives the speech signals from the speech acquirer 101, and sequentially performs speech recognition on the speech signals to generate a recognition result character string which is obtained as a result of the speech recognition. Herein, speech recognition for continuous speech (conversation) is assumed. A common speech recognition process, such as a hidden Markov model, a phonemic discrimination technique in which a deep neural network is applied, and an optimal word sequence search technique using a weighted finite state transducer (WFST), may be adopted; thus, a detailed explanation of such common speech recognition process is omitted.

In a speech recognition, a process of sequentially narrowing down word sequences to plausibly correct word sequences from the beginning to the end of the utterance, based on information, such as a word dictionary and a language model, is carried out. Therefore, if a plurality of undetermined word sequences are not narrowed down to probable ones in the above process, a word sequence ranked as the first in the priority at some point in time may be changed to a different word sequence, depending on speech signals obtained later. Accordingly, a correct translation result cannot be obtained if an intermediate speech recognition result is machine-translated. To determine a word sequence as a result of speech recognition, it is only possible when a linguistic component having no ambiguity appears, or when a pause in an utterance (e.g., a voiceless section longer than 200 milliseconds) is detected.

The translation segment detector 103 receives a recognition result character string from the speech recognizer 102, detects translation segments suitable for machine translation, and generates translation-segmented character strings which are obtained by dividing a recognition result character string based on the detected translation segments.

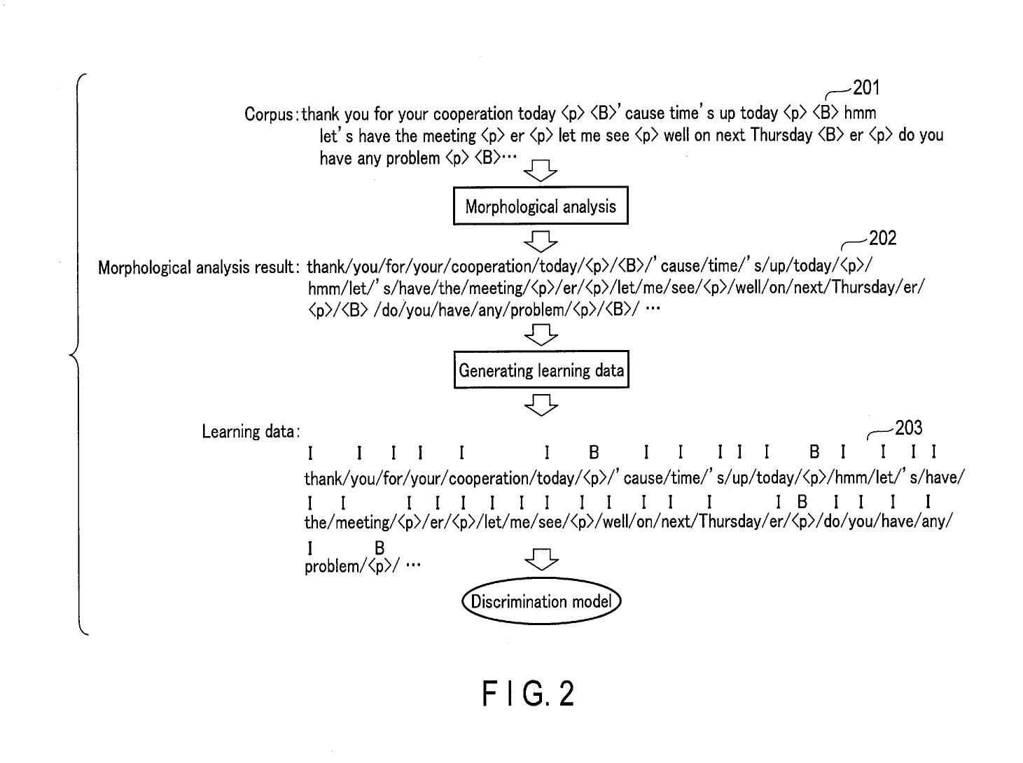

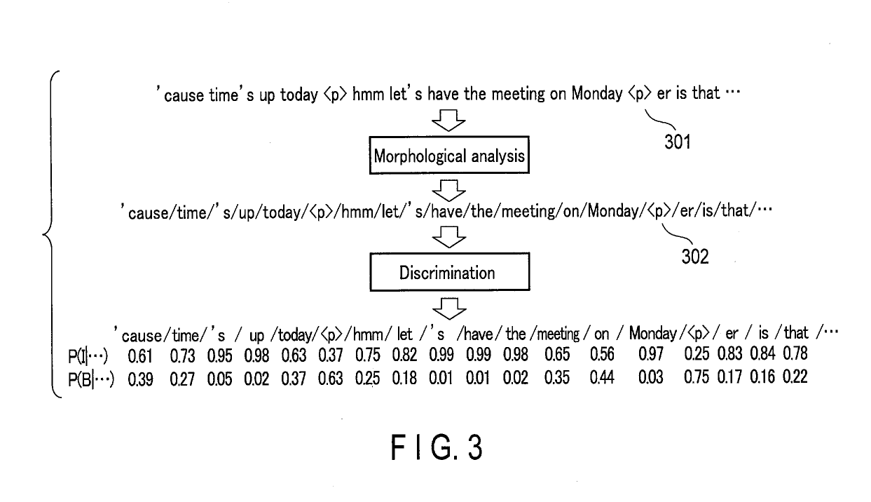

Spontaneous spoken languages are mostly consecutive, and it is difficult to identify boundaries between lexical or phonological segments, unlike written languages which contain punctuation. Accordingly, to realize speech translation with high simultaneity and good quality, it is necessary to divide a recognition result character string into segments suitable for translation. For the method of detecting translation segments adopted in the present embodiment, it is expected to use at least pauses in a speech, and fillers in an utterance as clues for detecting translation segments. The details will be described later with reference to FIGS. 2 and 3. A common method of detecting translation segments may be adopted.

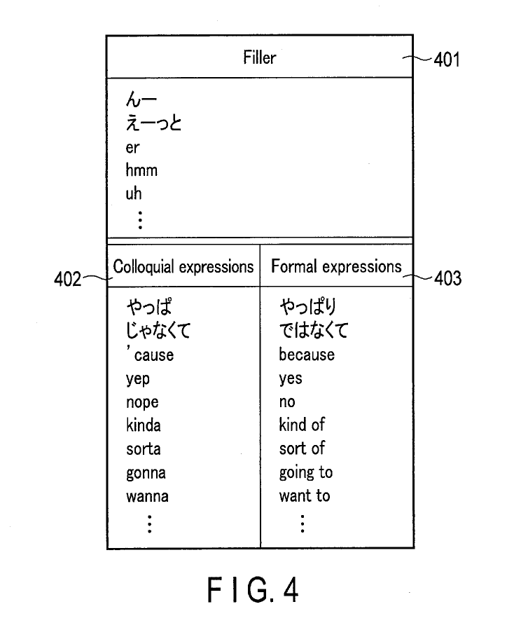

The words and phrases convertor 104 receives the translation-segmented character strings from the translation segment detector 103, and converts the translation segmented-character strings into converted character strings which are suitable for machine translation. Specifically, the words and phrases convertor 104 deletes unnecessary words in the translation-segmented character strings by referring to a conversion dictionary, and converts colloquial expressions in the translation segmented character strings into formal expressions to generate converted character strings. Unnecessary words are, for example, fillers such as “um” and “er”. The details of the conversion dictionary referred to by the words and phrases convertor 104 will be described later with reference to FIG. 4.

The machine translator 105 receives the converted character strings from the words and phrases convertor 104, translates the character strings in the first language into a target language (hereinafter “the second language”), and generates translated character strings. For the translation process at the machine translator 105, known machine translation schemes such as a transfer translation scheme, a usage example translation scheme, a statistic translation scheme, and an intermediate language translation scheme may be adopted; accordingly, the explanation of the translation process is omitted.

The display 106, which is, for example, a liquid crystal display, receives the converted character string and the translated character string from the machine translator 105, and displays them in a pair.

It should be noted that the speech translation apparatus 100 may include an outputting unit which outputs at least either one of the converted character strings and the translated character strings in an audio format.

Next, an example of the method for detecting translation segments is described with reference to FIGS. 2 and 3.

FIG. 2 illustrates an example of generating a model for discriminating translation segments. FIG. 2 indicates a process when a discrimination model is generated before starting operation of the translation segment detector 103.

In the example illustrated in FIG. 2, a morphological analysis result 202, which is obtained by performing a morphology analysis on a corpus 201 for learning, is shown. Herein, the label <P> in a sentence indicates a pause in the speech, and the label <B> indicates a position of a morpheme that can become a starting point of a translation segment. The label <B> is manually inserted in advance.

Subsequently, the translation segment detector 103 converts the morphological analysis result 202 into learning data 203 to which labels indicating a position to divide the sentence (class B) and a position to continue the sentence (class I) are added. It is assumed that the learning herein is learning by conditional random fields (CRF). Specifically, a conditioned probability is learned as a discrimination model, using the learning data 203 as input. The probability is conditioned by whether a morpheme sequence is to divide a sentence, or whether a morpheme sequence is to continue a sentence. In the learning data 203, the label <I> means a position of a morpheme in the middle of a translation segment.

FIG. 3 shows an example of detection of translation segments using two-class discrimination model (i.e., a model discriminating class B and class I) which is obtained by the process illustrated in FIG. 2.

The translation segment detector 103 performs morphological analysis on the recognition result character string 301 to obtain morphological analysis result 302. The translation segment detector 103 refers to the discrimination model to determine whether a target morphological sequence is a morphological sequence that divides a sentence, or a morphological sequence that continues a sentence. For example, if a value of conditional probability P (B|up, today, <p>) is greater than P (I|up, today, <p>), <p> is determined to be a dividing position (translation segment). Therefore, the character string “‘cause time's up today”, which is the first half of <p>, is generated as a translation-segmented character string.

Next, an example of a conversion dictionary referred to in the words and phrases convertor 104 will be explained with reference to FIG. 4.

FIG. 4 shows a conversion dictionary storing a list of fillers 401, colloquial expressions 402, and formal expressions 403. For example, “ [symbol] ” (“um”) and “ [symbol] ” (“er”) are stored as fillers 401 in the conversion dictionary, and if “ [symbol] ” or “ [symbol] ” are included in a translation-segmented character string, the words and phrases convertor 104 deletes such fillers from the translation segment character unit.

If a colloquial expression in the translation-segmented character string corresponds to the colloquial expression 402, the colloquial expression is changed to the formal expression 403. For example, if the colloquial expression 402 “‘cause” is included in the translation-segmented character string, the colloquial expression 402 “‘cause” is converted to the formal expression 403 “because”.

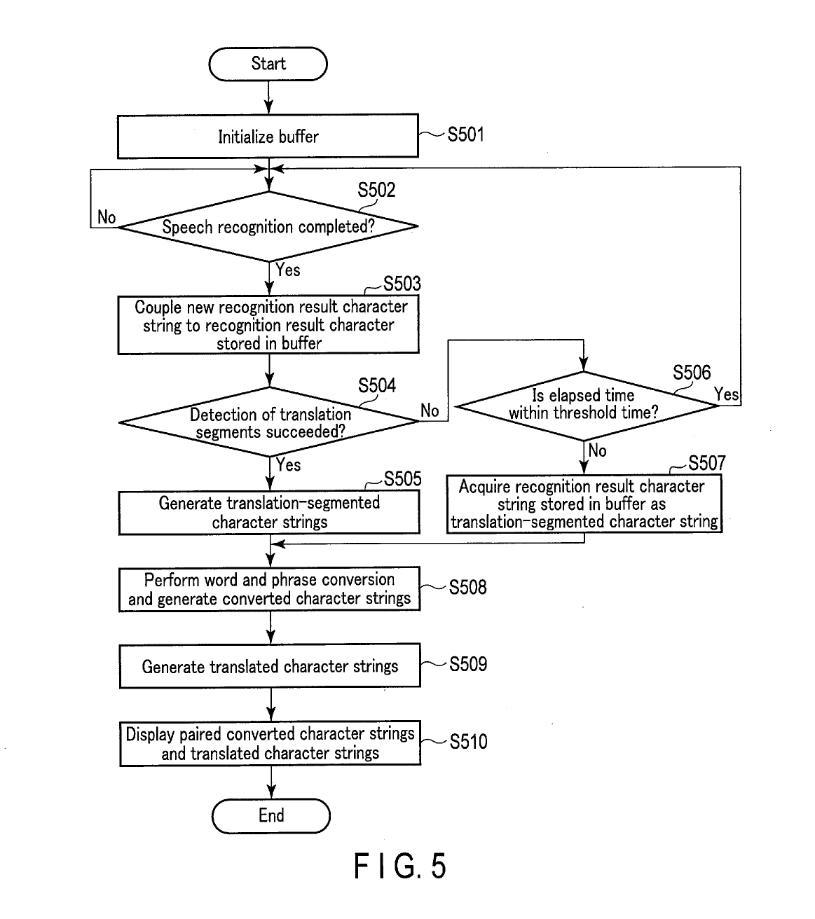

Next, an operation of the speech translation apparatus 100 according to the first embodiment will be described with reference to the flowchart of FIG. 5.

Herein, the operation up to the step of displaying converted character strings and translated character strings on the display 106 will be described. The description is on the assumption that the speech acquirer 101 consecutively acquires speech, and the speech recognizer 102 consecutively performs speech recognition on speech signals.

In step S501, the speech recognizer 102 initializes a buffer for storing recognition result character strings. The buffer may be included in the speech recognizer 102, or may be an external buffer.

In step S502, the speech recognizer 102 determines if the speech recognition is completed or not. Herein, completion of speech recognition means a status where the determined portion of the recognition result character string is ready to be outputted anytime to the translation segment detector 103. If the speech recognition is completed, the process proceeds to step S503; if the speech recognition is not completed, the process returns to step S502 and repeats the same process.

In step S503, the speech recognizer 102 couples a newly-generated recognition result character string to the recognition result character string stored in the buffer. If the buffer is empty because it is the first time to perform speech recognition or for other reasons, the recognition result character string is stored as-is.

In step S504, the translation segment detector 103 receives the recognition result character string from the buffer, and attempts to detect translation segments from the recognition result character strings. If the detection of translation segments is successful, the process proceeds to step S505; if the detection is not successful, in other words, there are no translation segments, the process proceeds to step S506.

In step S505, the translation segment detector 103 generates a translated segment character string based on the detected translation segments.

In step S506, the speech recognizer 102 determines if an elapsed time is within a threshold length of time. Whether or not an elapsed time is within a threshold length of time can be determined by measuring, with a timer for example, a time that has elapsed since the recognition result character string was generated. If the elapsed time is within a threshold length of time, the process returns to step S502, and repeats the same process. If the elapsed time exceeds a threshold length of time, the operation proceeds to step S507.

In step S507, the translation segment detector 103 acquires recognition result character strings stored in the buffer as translation-segmented character strings.

In step S508, the words and phrases convertor 104 deletes unnecessary words from the translation-segmented character strings and converts the colloquial expressions into literary expressions to generate converted character strings.

In step S509, the machine translator 105 translates the converted character strings in a first language into a second language, and generates translated character strings.

In step S510, the display 106 displays a paired converted character string and translated character string. This concludes the operation of the speech translation apparatus 100 according to the first embodiment.

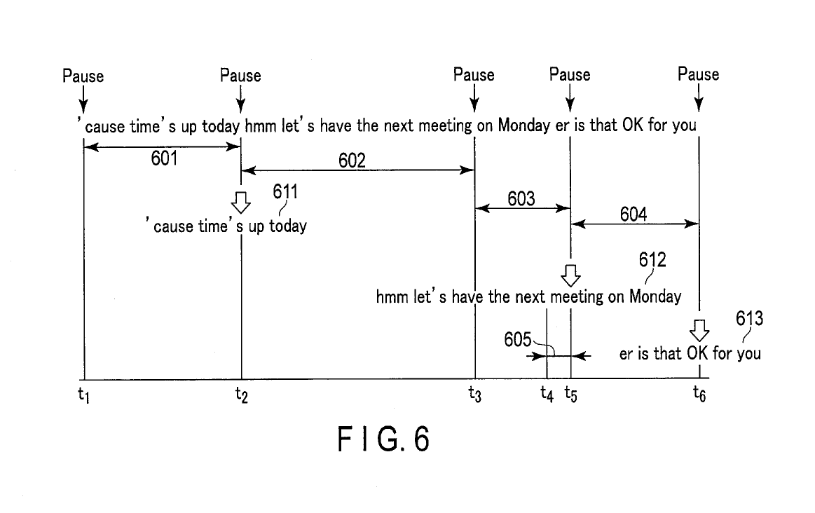

Next, a timing of generating a recognition result character string and a timing of detecting translation segments will be explained with reference to FIG. 6.

The top line in FIG. 6 is a recognition result character string which is a result of speech recognition. The character strings below the top recognition result character string are translation-segmented character strings, and they are displayed in chronological order at the timing of detection.

When the user pauses their utterance, and a time longer than a threshold length of time elapses (for example, when a pause period longer than 200 milliseconds is detected), the speech recognizer 102 determines the speech recognition results acquired before this pause. Thus, the speech recognition result is ready to be outputted. Herein, as shown in FIG. 6, if pauses are detected at t₁, t₂, t₃, t₄, t₅, and t₆, the speech recognizer 102 determines the recognition result character string.

The translation segment detector 103 receives the recognition result character string in the period 601 at t₁, receives the recognition result character string in the period 602 at t₃, receives the recognition result character string in the period 603 at t₅, and receives the recognition result character string in the period 604 at t₆.

On the other hand, there are cases both of when the translation segment detector 103 can detect, and cannot detect translation segments in an acquired recognition result character string.

For example, the recognition result character string in the period 601 “‘cause time's up today” can be determined as a translation segment by the process described above with reference to FIG. 3, and it can be generated as a translation-segmented character string 611. On the other hand, although there is a pause in between, the recognition result character string in the period 602 “hmm, let's have the next meeting” cannot be determined as a translation segment because it is unclear whether the sentence continues or not.

Accordingly, the recognition result character string “hmm, let's have the next meeting” is not determined as a translation-segmented character string until the speech recognition result in the next period 603 becomes available, and then at t₅, the character string coupled with the recognition result character string in the period 603 is processed as a target. It is now possible to detect a translation segment, and the translation segment detector 103 can generate the translation-segmented character string 612 “hmm let's have the next meeting on Monday”.

As a result of detecting a translation segment, there are cases where the latter half of the recognition result character string is determined as a subsequent translation segment. For example, at the point in time when the translation-segmented character string 612 is generated, the recognition result character string “er” generated during the period 605 is not determined as a translation segment, and it stands by until the subsequent speech recognition result becomes available. The recognition result character string in the period 604 coupled with the recognition result character string in the period 605 is detected at t₆ as a translation-segmented character string 613 “er is that OK for you”.

Thus, the translation segment detector 103 consecutively reads, in chronological order, the recognition result character strings generated by the speech recognizer 102 in order to detect translation segments and generate translation-segmented character strings. In FIG. 6, a speech recognition result is expected to be generated when a pause is detected. However, the speech recognizer 102 may be configured to determine a recognition result character string when a linguistic component having no ambiguity is detected by the speech recognizer 102.

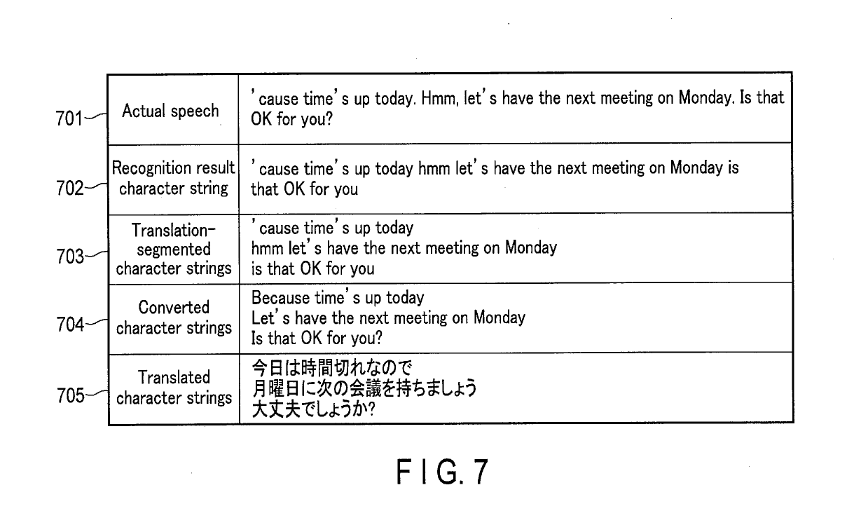

Next, the specific example of character strings outputted at each of the units constituting the speech translation apparatus will be explained with reference to FIG. 7.

As shown in FIG. 7, suppose a speech 701 “‘cause time's up today hmm let's have the next meeting on Monday is that OK for you?” is acquired from the user.

The speech recognizer 102 performs speech recognition on the speech 701, and a recognition result character string 702 “‘cause time's up today hmm let's have the next meeting on Monday is that OK for you?” is acquired.

Subsequently, three translation-segmented character strings 703 “‘cause time's up today”, “hmm let's have a next meeting on Monday”, and “is that OK for you” are generated by detecting translation segments in the recognition result character string 702 by the translation segment detector 103.

Subsequently, the words and phrases convertor 104 deletes the filler “hmm” in the translation-segmented character string 703, and converts the colloquial expression “‘cause” to the formal expression “because”, and the translation-segmented character string 703 generates the converted character strings 704 “because time's up today”, “let's have the next meeting on Monday”, and “is that OK for you?”.

Finally, the machine translator 105 translates the converted character strings 704 from the first language to the second language. In this embodiment, the converted character strings 704 are translated from English to Japanese, and the translated character strings 705 “ [symbol] [symbol] ” and “ [symbol] [symbol] ” are generated.

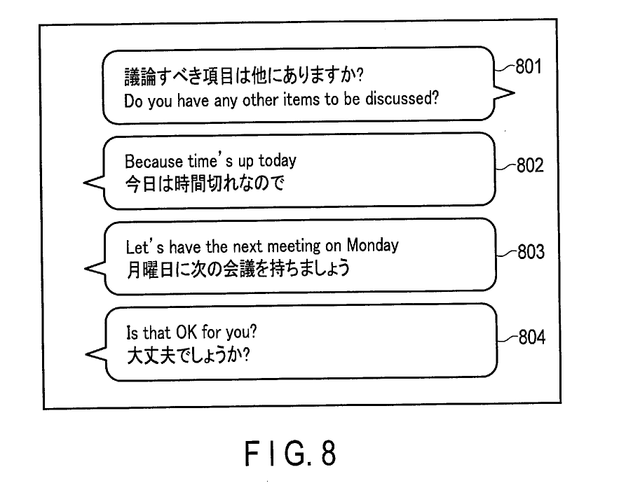

Next, the display example in the display 106 will be explained with reference to FIG. 8.

As shown in FIG. 8, a paired converted character string “ [symbol] [symbol] ” and the translated character string “Do you have any other items to be discussed?” are displayed in a balloon 801 as a user's utterance. In response to the utterance, a balloon 802, a balloon 803, and a balloon 804 are displayed at the timing of generating the translated character strings in chronological order. For example, the converted character string “because time's up today.” and the corresponding translated character string “ [symbol] [symbol] ” are displayed as a pair in the balloon 802.

According to the above-described first embodiment, a machine translation result that a user intended and smooth spoken communication can be realized by deleting unnecessary words in the translation-segmented character string and converting colloquial expressions in the translation-segmented character string into formal expressions.

### Second Embodiment

When a speech translation apparatus is expected to be used in a speech conference system, different languages may be spoken. In this case, there may be a variety of participants at the conference; a participant who has high competence of a language spoken by another participant and can understand the language by listening, a participant who can understand a language spoken by another participant by reading, and a participant who cannot understand a language spoken by another participant at all and needs the language to be translated into their language.

The second embodiment is on the assumption that a plurality of users use a speech translation apparatus, like the one used in a speech conference system.

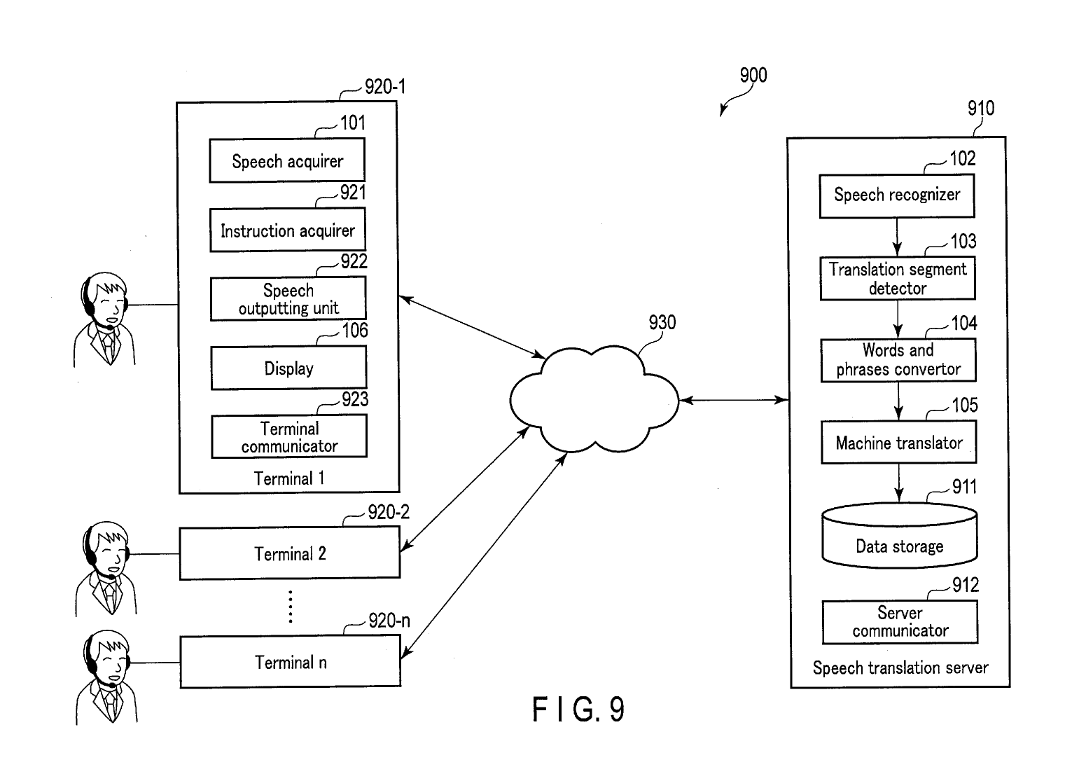

A speech translation system according to the second embodiment is described with reference to FIG. 9.

The speech translation system 900 includes a speech translation server 910 and a plurality of terminals 920.

In the example shown in FIG. 9, the terminal 920-1, the terminal 920-2, and the terminal 920-n (n is a positive integer greater than 3) are respectively used by a user. In the following explanation, the terminal 920-1 represents all of the terminals 920 for the sake of brevity.

The terminal 920 acquires speech from the user, and transmits the speech signals to the speech translation server 910.

The speech translation server 910 stores the received speech signals. The speech translation server 910 further generates translation-segmented character strings, converted character strings, and translated character strings and stores them. The speech translation server 910 transmits converted character strings and translated character strings to the terminal 920. If converted character strings and translated character strings are sent to a plurality of terminals 920, the speech translation server 910 broadcasts those character strings to each of the terminals 920.

The terminal 920 displays the received converted character strings and translated character strings. If there is an instruction from the user, the terminal 920 requests the speech translation server 910 to transmit the speech signal in a period corresponding to a converted character string or translated character string instructed by the user.

The speech translation server 910 transmits partial speech signals that are speech signals in the period corresponding to a converted character string or a translated character string in accordance with the request from the terminal 920.

The terminal 920 outputs the partial speech signals from a speaker or the like as a speech sound.

Next, the details of the speech translation server 910 and the terminals 920 will be explained.

The translation speech server 910 includes a speech recognizer 102, the translation segment detector 103, the words and phrases convertor 104, the machine translator 105, the data storage 911, and the server communicator 912.

The operations of the speech recognizer 102, the translation segment detector 103, the words and phrases convertor 104, and the machine translator 105 are the same as those in the first embodiment, and descriptions thereof will be omitted.

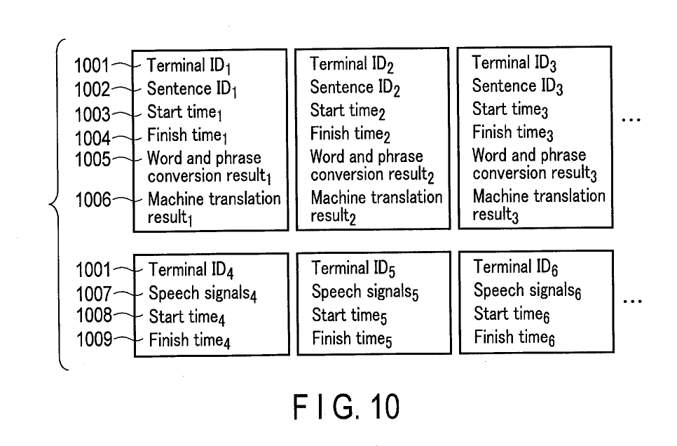

The data storage 911 receives speech signals from each of the terminals 920, and stores the speech signal and a terminal ID of a terminal which transmits the speech signals, and they are associated with each other when they are stored. The data storage 911 receives translation-segmented character strings, etc., and stores them. The details of the document data storage 911 will be described later with reference to FIG. 10.

The server communicator 912 receives speech signals from the terminal 920 via the network 930, and carries out data communication, such as transmitting the translated character strings and the converted character strings to the terminal 920, and so on.

Next, the terminal 920 includes the speech acquirer 101, the instruction acquirer 921, the speech outputting unit 922, the display 106, and the terminal communicator 923.

The operations of the speech acquirer 101 and the display 106 are the same as those in the first embodiment, and descriptions thereof will be omitted.

The instruction acquirer 921 acquires an instruction from the user. Specifically, an input by the user, such as a user's touch on a display area of the display 106 using a finger or pen, is acquired as a user instruction. An input by the user from a pointing device, such as a mouse, can be acquired as a user instruction.

The speech outputting unit 922 receives speech signals in a digital format from the terminal communicator 923 (will be described later), and performs digital-to-analog conversion (DA conversion) on the digital speech signals to output the speech signal in an analog format from, for example, a speaker as a speech sound.

The terminal communicator 923 transmits speech signals to the speech translation server 910 via the network 930, and carries out data communication such as receiving speech signals, converted character strings, and translated character strings, etc. from the speech translation server 910, and so on.

Next, an example of data stored in the data storage 911 will be explained with reference to FIG. 10.

The data storage 911 includes a first data region for storing data which is a result of the process on the speech translation server 910 side, and a second data region for storing data related to speech signals from the terminal 920. Herein, the data regions are divided into two for the sake of explanation; however, in the actual implementation, the data region can be one, or more than two.

The first data region stores a terminal ID 1001, a sentence ID 1002, a start time 1003, a finish time 1004, a words and phrases conversion result 1005, and a machine translation result 1006, and they are associated with each other when they are stored.

The terminal ID 1001 is an identifier given to each terminal. The terminal ID 1001 may be substituted by a user ID. The sentence ID 1002 is an identifier given to each translation-segmented character string. The start time 1003 is a time when a translation-segmented character string to which the sentence ID 1002 is given starts. The finish time 1004 is a time when a translation-segmented character string to which the sentence ID 1002 is given finishes. The word and phrase conversion result 1005 is a converted character string generated from a translation-segmented character string to which the sentence ID 1002 is given. The machine translation result 1006 is a translated character string generated from a converted character string. Herein, the start time 1003 and the finish time 1004 are values corresponding to times of each of a corresponding word and phrase conversion result 1005, and a corresponding machine translation result 1006.

The second data region includes the terminal ID 1001, the speech signal 1007, the start time 1008, and the finish time 1009.

The speech signal 1007 is a speech signal received from the terminal ID 1001. The start time 1008 is a start time of the speech signal 1007. The finish time 1009 is a finish time of the speech signal 1007. The unit of data stored in the second data region is a unit of a recognition result character string generated by the speech recognizer 101; thus, the start time 1008 and the finish time 1009 will be the values corresponding to the recognition result character string. In other words, a speech signal (a partial speech signal) corresponding to the recognition result character string between the start time 1008 and the finish time 1009 is stored as the speech signal 1007.

The word and phrase conversion result 1005 and the machine translation result 1006 corresponding to the terminal ID 1001 and the sentence ID 1002 may be stored in the terminal 920. Thus, at the terminal 920, when there is an instruction from the user for the converted character strings and translated character strings, it is possible to read the corresponding speech signal from the data storage 911 as soon as possible, thereby increasing the processing efficiency.

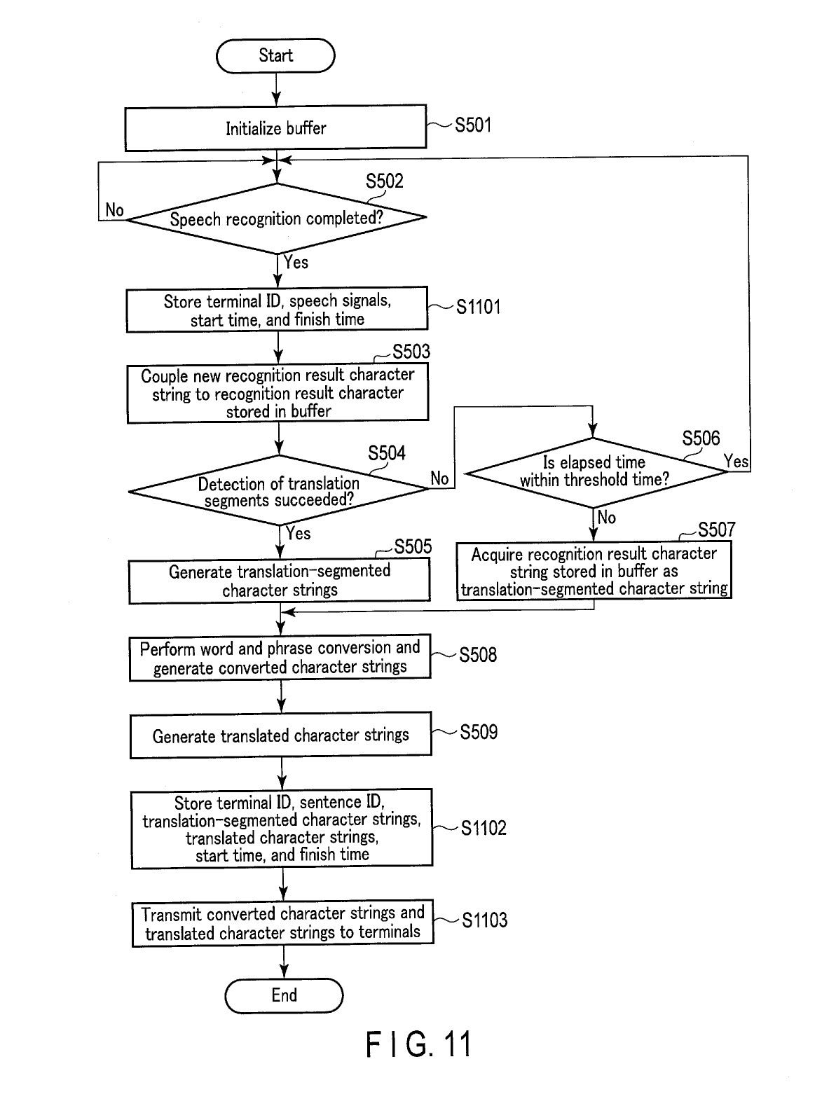

Next, an operation of the speech translation server 910 according to the second embodiment will be described with reference to the flowchart of FIG. 11.

Steps S501 to S509 are the same as those in the first embodiment, and descriptions thereof are omitted.

In step S1101, the speech recognizer 102 receives the terminal ID and speech signals from the terminal 920, and the data storage 911 stores speech signals, a start time, and a finish time corresponding to a recognition result character string which is a processing result at the speech recognizer 102, and the speech signals, the start time, and the finish time are associated with each other when they are stored.

In step S1102, the data storage 911 stores the terminal ID, the sentence ID, the translation-segmented character strings, the converted character strings, the translated character strings, the start time, and the finish time, and they are associated with each other when they are stored.

In step S1103, the speech translation server 910 transmits the converted character strings and the translated character strings to the terminal 920.

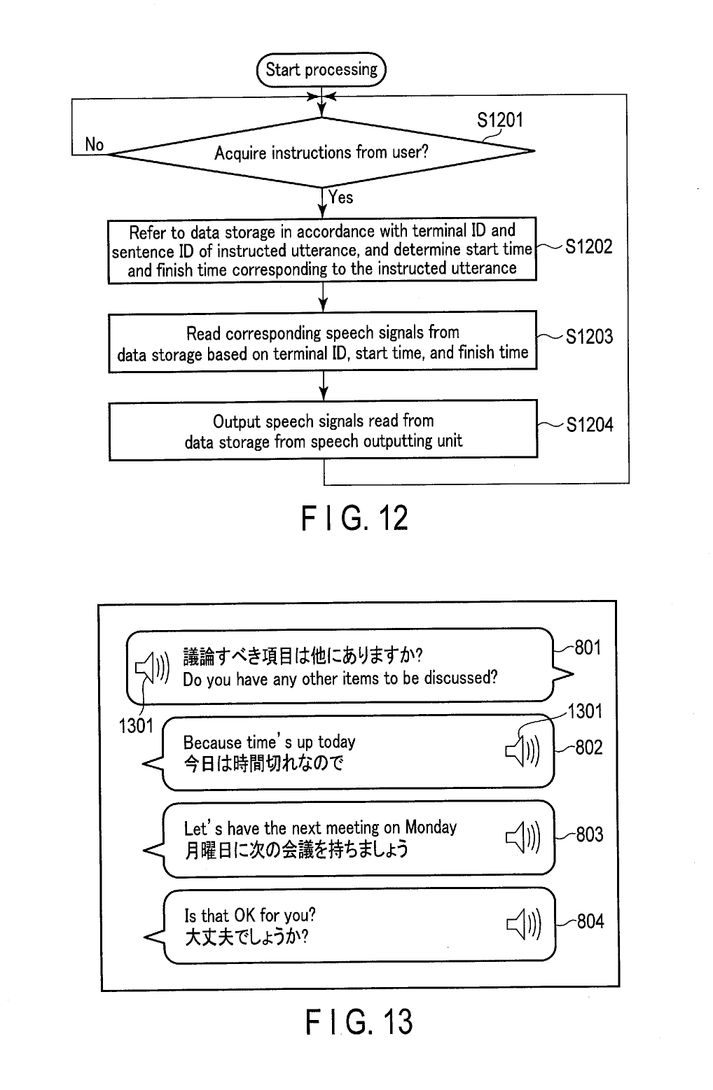

Next, the speech output process at the terminal 920 will be explained with reference to the flowchart of FIG. 12.

In step S1201, the instruction acquirer 921 determines whether or not the user's instruction is acquired. If the user instruction is acquired, the process proceeds to step S1202; if no user instruction is acquired, the process stands by until a user instruction is acquired.

In step S1202, the instruction acquirer 921 acquires the corresponding start time and the finish time referring to the speech translation server 910 and the data storage 911, based on the terminal ID and the sentence ID of the sentence instructed by the user.

In step S1203, the instruction acquirer 921 acquires speech signals of the corresponding period (partial speech signals) from the data storage 911 based on the terminal ID, the start time, and the finish time.

In step S1204, the speech outputting unit 922 outputs the speech signals. This concludes the speech outputting process at the terminal 920.

Next, an example of the display in the display 106 according to the second embodiment is explained with reference to FIG. 13.

In the example shown in FIG. 13, an icon 1301 is displayed in addition to the balloon 801 through the balloon 804 of FIG. 8. When the user touches the icon 1301, partial speech signals corresponding to the converted character string or the translated character string in the balloon are output as sound.

Specifically, if the user wants to hear the sound associated with “because time's up today” in the balloon 802, the user touches the icon 1301 next to the balloon, and the sound “‘cause time's up today” corresponding to “because time's up today” is outputted.

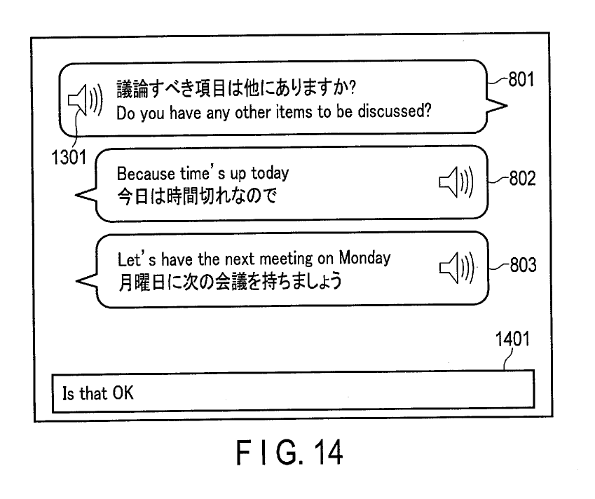

Next, the first additional example of a display at the display 106 will be explained with reference to FIG. 14.

In the present embodiment, the speech from the user is acquired at the speech acquirer 101, and the speech recognizer 102 of the speech translation server 910 stores the recognition result character string that is a speech recognition result in the buffer, while the translation segment detector 103 detects translation segments from the first part of the recognition result character string. Accordingly, there may be a time lag in displaying translated character strings in the display 106.

Thus, as shown in FIG. 14, at the point of time when the recognition result character string is acquired, the recognition result character string may be displayed on the display area 1401 from the time when translation-segmented character strings are generated until the time when translated character strings are generated. Thus, it is possible to reduce a time lag in displaying a recognition result character string. Furthermore, if translated character strings are acquired, the recognition result character string displayed on the display area 1401 may be deleted.

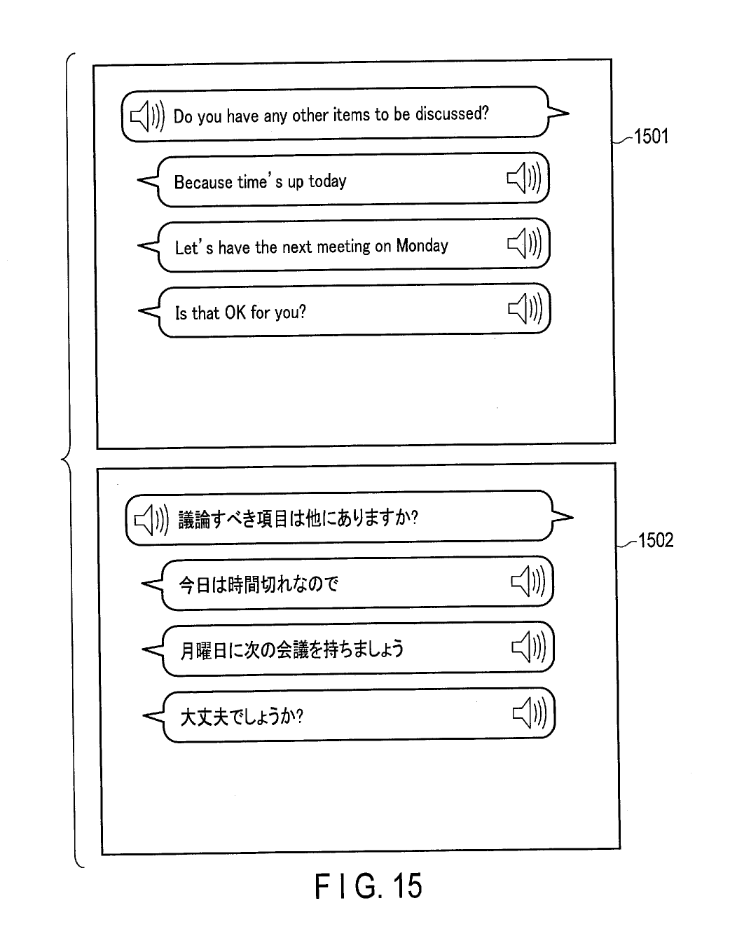

Next, another example of the display at the display 106 will be explained with reference to FIG. 15.

For example, there is a case where a user who cannot understand at all a language of other speaker at a speech conference, etc. may not need the display of the language. In this case, the converted character strings, or the translated character strings of a language of other speaker are turned off. As shown in FIG. 15, for a user who speaks English as their native language, English is displayed in a balloon 1501, and for a user who speaks Japanese, Japanese is displayed in a balloon 1502.

On the other hand, for a user who can understand the other party's language to some extent but does not have good listening skills, the translated character strings are turned off, and only the converted character strings are displayed.

In the above-described second embodiment, the speech recognizer 102, the words and phrases convertor 104, and the machine translator 105 are included in the speech translation server 910, but may be included in the terminal 920. However, when conversations involving more than two languages are expected, it is desirable to include at least the machine translator 105 in the speech translation server 910.

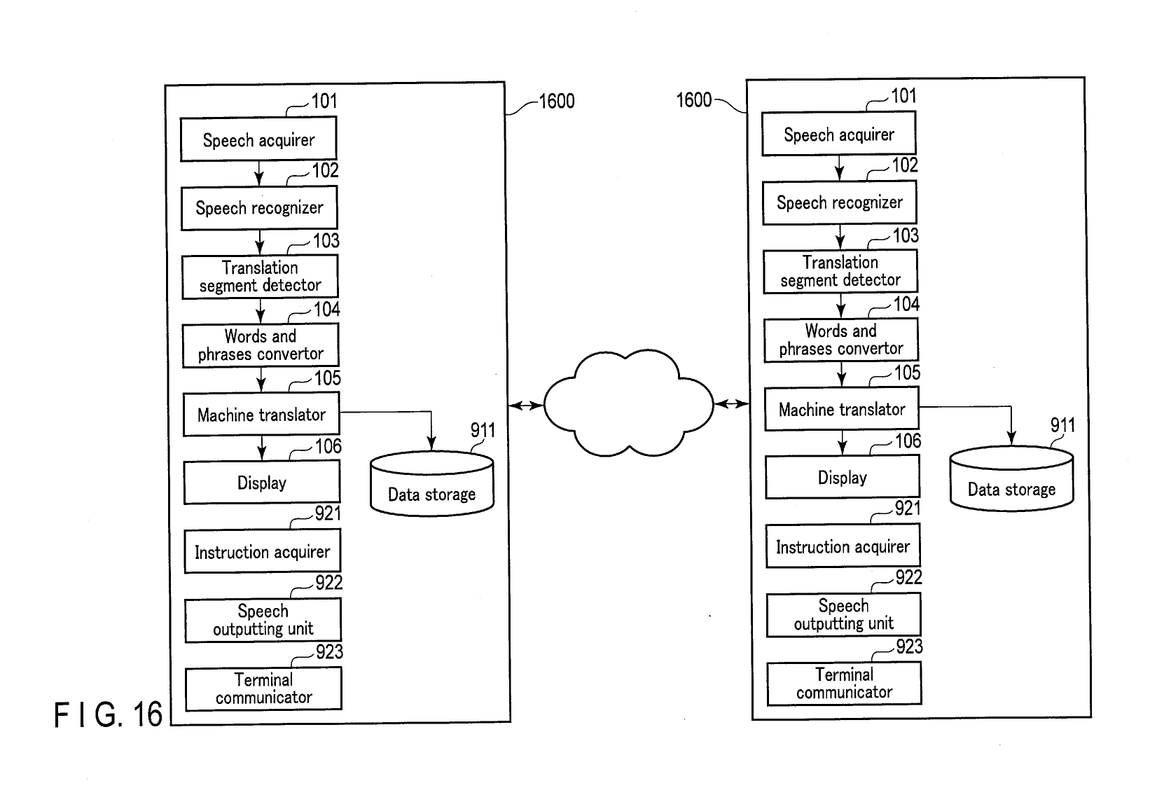

Terminals serving as speech recognition apparatuses having the structures of the above-described speech translation server 910, and the terminal 920 may directly carry out processing between each other, without the speech translation server 910. FIG. 16 is a block diagram showing the terminals when they direct carry out communication between each other.

A terminal 1600 includes a speech acquirer 101, a speech recognizer 102, a translation segment detector 103, a words and phrases convertor 104, a machine translator 105, a display 106, a data storage 911, a server communicator 912, an instruction acquirer 921, a speech outputting unit 922, and a terminal communicator 923. By this configuration, the terminals 1600 can directly communicate with each other, and perform the same processing as the speech translation system, thereby realizing a peer-to-peer (P2P) system.

According to the second embodiment described above, partial speech signals corresponding to a converted character string and a translated character string can be outputted in accordance with a user instruction. It is also possible to select a display that matches a user's comprehension level for smoothly spoken dialogue.

The flow charts of the embodiments illustrate methods and systems according to the embodiments. It is to be understood that the embodiments described herein can be implemented by hardware, circuit, software, firmware, middleware, microcode, or any combination thereof. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A speech translation apparatus, comprising:
a recognizer which recognizes a speech in a first language to generate a recognition result character string;
a detector which detects translation segments suitable for machine translation from the recognition result character string to generate translation-segmented character strings that are obtained by dividing the recognition result character string based on the detected translation segments;
a convertor which converts the translation-segmented character strings into converted character strings which are expressions suitable for the machine translation; and
a translator which translates the converted character strings into a second language which is different from the first language to generate translated character strings.

2. The apparatus according to claim 1, wherein when the translation-segmented character strings include unnecessary words, the convertor deletes the unnecessary words.

3. The apparatus according to claim 1, wherein the convertor converts colloquial expressions included in the translation-segmented character strings to formal expressions.

4. The apparatus according to claim 1, further comprising a display which displays the converted character strings and the translated character strings in association with each other.

5. The apparatus according to claim 4, wherein the display displays the recognition result character string from a time when the translation-segmented character strings are generated until a time when the translated character strings are generated.

6. The apparatus according to claim 4, wherein the display turns off either one of the first language or the second language for at least one of the converted character strings and the translated character strings.

7. The apparatus according to claim 1, wherein the detector performs a detection using pauses in the speech and fillers in an utterance as clues.

8. The apparatus according to claim 1, further comprising:
a speech acquirer which acquires the speech in the first language as speech signals;
a storage which stores the speech signals, a start time of the speech signals, a finish time of the speech signals, translation-segmented character strings generated from the speech signals, converted character strings converted from the translation-segmented character strings, and translated character strings generated from the converted character strings;
an instruction acquirer which acquires a user instruction; and
an outputting unit which outputs, as a speech sound, partial speech signals which are speech signals in a period corresponding to the converted character strings or the translated character strings in accordance with the user instruction.

9. A speech translation method, comprising:
recognizing a speech in a first language to generate a recognition result character string;
detecting translation segments suitable for machine translation from the recognition result character string to generate translation-segmented character strings that are obtained by dividing the recognition result character string based on the detected translation segments;
converting the translation-segmented character strings into converted character strings which are expressions suitable for the machine translation; and
translating the converted character strings into a second language which is different from the first language to generate translated character strings.

10. The method according to claim 9, further comprising deleting unnecessary words included in the translation-segmented character strings when the translation-segmented character strings include the unnecessary words.

11. The method according to claim 9, wherein the converting the translation-segmented character strings converts colloquial expressions included in the translation-segmented character strings to formal expressions.

12. The method according to claim 9, further comprising displaying the converted character strings and the translated character strings in association with each other.

13. The method according to claim 12, wherein the displaying displays the recognition result character string from a time when the translation-segmented character strings are generated until a time when the translated character strings are generated.

14. The method according to claim 12, wherein the displaying turns off either one of the first language or the second language for at least one of the converted character strings and the translated character strings.

15. The method according to claim 9, wherein the detecting the translation segments performs a detection using pauses in the speech and fillers in an utterance as clues.

16. The method according to claim 9, further comprising:
acquiring the speech in the first language as speech signals;
storing, in a storage, the speech signals, a start time of the speech signals, a finish time of the speech signals, translation-segmented character strings generated from the speech signals, converted character strings converted from the translation-segmented character strings, and translated character strings generated from the converted character strings;
acquiring a user instruction; and
outputting, as a speech sound, partial speech signals which are speech signals in a period corresponding to the converted character strings or the translated character strings in accordance with the user instruction.

17. A non-transitory computer readable medium including computer executable instructions, wherein the instructions, when executed by a processor, cause the processor to perform a method comprising:
recognizing a speech in a first language to generate a recognition result character string;
detecting translation segments suitable for machine translation from the recognition result character string to generate translation-segmented character strings that are obtained by dividing the recognition result character string based on the detected translation segments;
converting the translation-segmented character strings into converted character strings which are expressions suitable for the machine translation; and
translating the converted character strings into a second language which is different from the first language to generate translated character strings.

18. The medium according to claim 17, further comprising deleting unnecessary words included in the translation-segmented character strings when the translation-segmented character strings include the unnecessary words.

19. The medium according to claim 17, wherein the converting the translation-segmented character strings converts colloquial expressions included in the translation-segmented character strings to formal expressions.

20. The medium according to claim 17, further comprising displaying the converted character strings and the translated character strings in association with each other.
